(19) United States
(12) Patent Application Publication
(10) Pub. No.: US 2007/0100578 A1
(43) Pub. Date: May 3, 2007

(54) Phaseshift interferometer

(75) Inventor: Miroslaw Wrobel, Toronto (CA)

Correspondence Address: LANG MICHENER, BCE PLACE, P.O. BOX 747, SUITE 2500, 181 BAY STREET, TORONTO, ON, M5J 2T7, CA

(73) Assignee: Nimtech Inc.

(21) Appl. No.: 11/262,748

(22) Filed: Nov. 1, 2005

(51) Int. Cl. G01B 11/14

(52) U.S. Cl. 702/159

(57) ABSTRACT

The present invention provides an investigation device for investigating a sample of a solid, liquid or gaseous medium. The device has a transmission mechanism capable of sending several transmitted signals of different frequencies and a receiving mechanism for receiving received signals corresponding to the various transmitted signals. The device further includes a processing mechanism for determining the phase shift of each pair of transmitted and received signals and computationally determining a qualifying value for the sample. The processing mechanism determines the qualifying value based on a comparison of the determined phase shift values with comparison phase shift values from a comparison sample intended for the respective transmitter frequencies. By using the frequency-specific scanning of the sample at multiple frequencies, the resulting determination of the frequency-specific phase angle shifts provides a substantially more accurate investigation of the sample, including when a change in the sample can result in different effects on the respective frequency-specific transmitted signals.

### FIELD OF THE INVENTION

The present invention relates to the field of devices for the analysis of solid, liquid and gaseous mediums. In particular, it relates to an interferometer that measures the phase shift between a series of transmitted signals and the corresponding reflected signals from the medium being analyzed.

### BACKGROUND OF THE INVENTION

Devices for measuring the density of sample media via phase shift interferometry are known in the art, such as the device disclosed by Glaser et al. in DE 10036565C2. With this device it is possible to evaluate the phase shift between a transmitted and a received signal and to draw conclusions from this shift. In particular, changes in the density of the medium through which the signal passes can be measured to determine, for example, changes in the composition of the medium. Using several receiver cells arranged line-by-line it is possible to get from a single transmitted signal several different received signals resulting from the different distances between the medium and the respective receiver cells.

Although with this device a gradual measurement of a change in the structural quality of a medium is possible, this measurement takes place using only one transmitter frequency.

Another device of this type is described by Redding in U.S. Pat. No. 4,119,950 for the measurement of gaseous media. This device measures a change in gas concentration, in order to be able to operate an alarm in the event of a measurement of a dangerous concentration of gas. The device must measure and quantify a change, in order to recognize a danger situation from a deviation in concentration and therefore trigger the alarm. To accomplish this measurement, a transmitted signal is sent and a phase difference from a corresponding received signal is determined, which will reflect a change in the gas composition. If the phase difference is large enough, the alarm is triggered. In one measurement cycle only a signal operating on a single frequency is sent and/or processed.

### SUMMARY OF THE INVENTION

The object of the invention is to provide a device which permits an improved investigation of the properties of a liquid or gaseous medium.

To further this object the present invention provides an investigation device for investigating a sample of a liquid or gaseous medium. The device has a transmission mechanism capable of sending several transmitted signals of different frequencies and a receiving mechanism for receiving received signals corresponding to the various transmitted signals. The device further includes a processing mechanism for determining the phase shift of each pair of transmitted and received signals and computationally determining a qualifying value for the sample. The processing mechanism determines the qualifying value based on a comparison of the determined phase shift values with comparison phase shift values from a comparison sample intended for the respective transmitter frequencies.

By using the frequency-specific scanning of the sample at multiple frequencies, the resulting determination of the frequency-specific phase angle shifts provides a substantially more accurate investigation of the sample, including when a change in the sample can result in different effects on the respective frequency-specific transmitted signals.

The qualifying value describes the total of the frequency-specific phase shift values as compared to comparison phase shift values of a well-known comparison sample, using the same transmitter frequencies. The final result is thus that qualifying value (although several can be determined, e.g. value for each of multiple comparison sample) provides a statement about how the investigation sample behaves compared with a comparison sample, and thus, how similar the investigation sample is to the comparison sample.

For the comparison, is it preferable that the processing mechanism compares each determined phase shift with a value interval in which the frequency-specific comparison phase shift values lie. A value interval is produced for each comparison phase shift value, with the value intervals laid out in such a manner that the contained comparison phase shift values all combine to provide the standard for comparison to the comparison sample. Thus if the phase shift value lies somewhere in the value interval, then the investigation sample is somewhat related to the comparison sample, i.e., corresponds to the standard defined from the comparison sample for this frequency. The use of value intervals enables a certain “Fuzzy Logic”, i.e. acknowledging that a phase shift value corresponds to the reference value even if there is not 100% agreement. Alternatively, it is also possible to use as a reference only comparison phase shift values and no interval values.

The processing mechanism preferably determines a reference value as a result of each comparison and then determines the qualifying value from these reference values. The reference value is thus, how the phase shift value and comparison phase shift value and/or the value interval agree for each frequency. For example, if the phase shift value lies in the value interval, then the reference value “I” is assigned, if it lies outside, “0” is assigned. These reference values are also used, if in place of a value interval a precise comparison phase value is used. For a more exact evaluation of the comparison it is particularly favourable, if the processing mechanism is using the value interval to determine the reference value, to describe the dependence of its relationship to the comparison phase shift value in the reference value. In other words, the reference value uses a weighting going by how the phase shift value lies within the value interval. For example, if the phase shift value lies precisely in the center of the value interval, a “1” is assigned to it as reference value. This value decreases with increasing distance to the edge of the value interval, with a value completely outside the interval assigned a “0”. Alternatively, the reference value can be weighted within the value interval e.g. according to a Gaussian function falling from “1” to “0” (or another distribution function).

The qualifying value of the investigation medium is then produced by summation and averaging of the reference values and used to determine how well the investigation sample agrees with the comparison sample. If a qualifying value of “1” results, then the investigation sample agrees completely with the comparison sample. In the described example that would mean that all phase shift values of the investigation sample lay right in the respective frequency-referred interval center, therefore all reference values are “1”. If a qualifying value of “0.95” results, then one or more phase shift values deviates from the interval center to deviate and therefore not all reference values were assigned as “1”. A qualifying value of “0.95” means that the investigation sample has 95% agreement with the comparison sample.

Preferably, the production of the transmit signal is provided by a signal generator, which is controlled by a modulator, and provides an output signal to the transmission mechanism. The processing mechanism may then determine the phase difference between the received signal and a transmission reference signal provided by the signal generator. This transmission reference signal matches the transmit signal corresponding to each received signal.

Preferably, the processing mechanism includes two multiplexers, of which one receives the transmission reference signals and the other one the received signals, whereby the multiplexers unify the respective pairs of signals. I.e., over the multiplexers a transmit or a transmission reference signal and the associated received signal are united and sent for processing downstream. For each pair of signals a memory element is provided downstream at the outlet side, to which the individual signals are sent, and the multiplexers couple the respective signals through to their respective memory element. In each case a multiplexer transmits the appropriate signal to the memory element, where the first in signal each case becomes buffered until the second signal is present, so that they can be processed together. The multiplexers switch in parallel from one memory element to the next, so that a continuous operation is possible. The switching operation of the multiplexers operates using the control signals from the generator for the signal transmission. For the determination of the phase shift a comparator is provided for each pair of transmit and received signals, in which the phase shift value is determined as described above.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a schematic of a device embodying the features of the present invention;

FIG. 2 is graph of the frequency and amplitude for a series of signals from the signal generator; and

FIG. 3 is a diagram of the phase shift comparison process executed by the processing element.

### DETAILED DESCRIPTION OF THE PREFERRED EMBODIMENTS

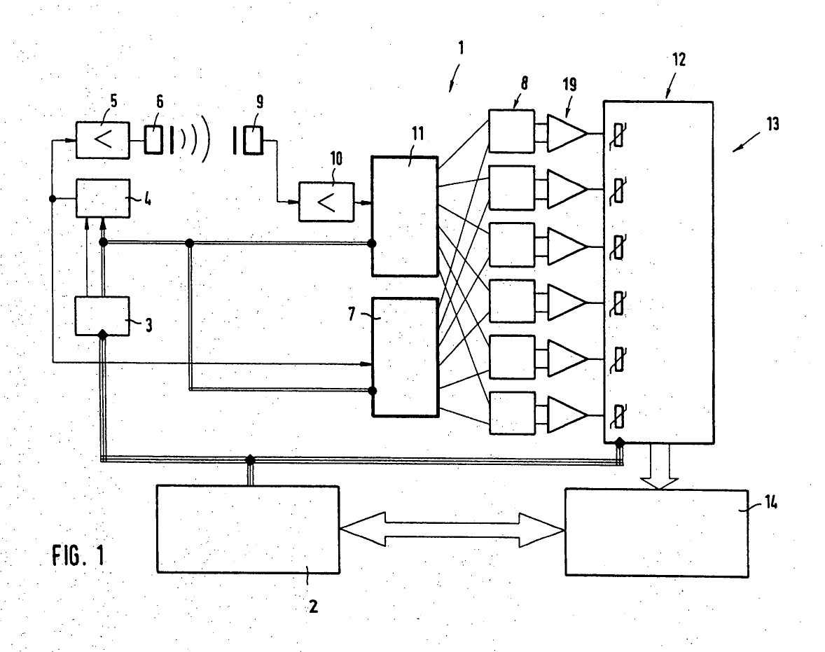

Referring now to FIG. 1, the invention in accordance with a presently preferred embodiment is indicated generally at 1. There is a control unit 2, which controls the operation of all other elements during a measurement cycle. To generate a transmission signal, control unit 2 sends the frequency, amplitude and transmission duration parameters necessary for each signal to a modulator 3. Using these parameters the modulator 3 operates a signal generator 4 that produces the necessary signals, which are then sent to a transmission mechanism 6, such as an ultrasonic transmitter, that is coupled to the investigation sample, the sample being a liquid or gaseous medium. If necessary, signal generator 4 may first pass the signals through an amplifier 5, which then sends an amplified signal to the transmission mechanism 6. The control over the signal generator 4 by the modulator 3 is handled by a step function, which controls a Voltage Controlled Oscillator (VCO—not shown) in the signal generator 4 via voltage levels. The transmission generation mechanism thus includes the modulator 3, the signal generator 4, the amplifier 5 and the transmission mechanism 6.

The output signal of the generator 4 is sent not only to the amplifier 5 and/or the transmission mechanism 6, but also to a first multiplexer 7. This signal sent to the first multiplexer 7 serves as a transmission reference signal for the subsequent determination of the phase shift values. The first multiplexer 7 distributes the transmission reference signal to the first entrance of a currently assigned memory element 8 of a group of memory elements. The number of memory elements is equal to the number of individual frequency stages that are driven in a single measurement cycle.

After receiving the signal from the generator 4, the transmission mechanism 6 sends the transmitted signal through the investigation sample, which is typically flowing through a standing pipe or similar carrier. A receiving mechanism 9 receives a received signal that has gone through the sample, which is sent to an amplifier 10 and passed on to a second multiplexer 11. The second multiplexer 11 now gives the respective received signal to a second entrance in the currently assigned memory element 8. Thus both the transmission reference signal from the first multiplexer 7 as well as the received signal from the second multiplexer 11 corresponding to the reference signal are stored in the currently assigned memory element 8.

The multiplexers 7 and 11 are then switched to next assigned memory element 8, as the next signal block is sent on a different frequency, i.e. for each frequency, a transmission reference signal and received signal, which form a pair of signals which can be evaluated together, are distributed over the multiplexers 7 and 11 to a different assigned memory element 8. The switching operation is controlled via the frequency response of the transmitted signal output of the modulator 3. This signal is given as a switching signal on the two multiplexers 7 and 11, so that they switch at the same time to the next switching element in correlation with the frequency switching of the modulator 3.

Both the transmission reference signal and assigned received signal are sent from a respective memory element 8, to a respective comparator 19. The respective comparator 19 compares the two signals with one another and determines their phase relationship, i.e., the phase shift and/or the phase angle between the transmission reference signal (corresponding to the transmitted signal) and the received signal. This phase shift value or phase shift angle is sent to a processing element 12, to determine, for a respective frequency, where a certain phase shift value or phase shift angle lies relative to a reference value. For this purpose, the appropriate comparison phase shift values for a comparison sample of the medium are called up from the control unit 2 and stored on the processing element 12. The processing element 12 combines with the multiplexers 7 and 11 as well as the memory elements 8 and the comparators 19 to form the processing mechanism 13.

These comparison phase shift values are taken from a qualified standard comparison sample and serve as a reference for the sample under investigation. Each comparison phase shift value was originally measured at the same frequency and amplitude as the transmitted signal. The processing element 12 determines how the phase shift value for the sample under investigation compares to the phase shift value of the comparison sample. The processing element 12 assigns the difference in the two values a reference value. This reference value can be, for example, “1” for agreement with the reference and “0” for deviation from the reference. Alternatively, the reference value can range from “100” to “0” to indicate a percentage of purity of a substance.

During operation of the device according to the invention, successive signal packages of different frequencies are sent. The frequencies are ideally within the range between 1-15 MHz, with each signal package covering at least 1 period, and the signal packages provided in defined frequency stages. For each signal package and thus for each frequency stage the specific received signals are received by the receipt mechanism (although to keep each set of received signals separate there may naturally also be several receiving mechanisms). Then the processing mechanism looks at each frequency-specific pair of transmitted and received signals and determines the phase shift angle between the two signals caused by travel through the sample. In the final result, by using this frequency-specific scanning of the sample a multiplicity of different frequency-specific phase shift values is determined, whose number is dependent on the number of frequency stages. In this way the information about the behaviour of the sample is determined over a large frequency range, defined by the individual frequency stages.

As described above, different transmitted signals are sent in succession with different frequencies and amplitude, resulting in a several sequences of transmission signals. Accordingly, many corresponding received signals are recorded, requiring many memory elements and comparators be included for separate frequency stages. For each pair of signals in the processing element 12 the phase shift value is compared to the comparison phase shift value of the comparison sample to get a reference value. Once all reference values are present, a qualifying value is generated by summation and averaging of these individual reference values. This qualifying value is sent to a suitable display 14 (preferably the same station as the one for input of control information for the control unit 2). This qualifying value, which describes a reference value distribution between “1” and “0”, with a maximum of “1” and a minimum of “0”, indicates how well the sample under investigation agrees with the comparison sample.

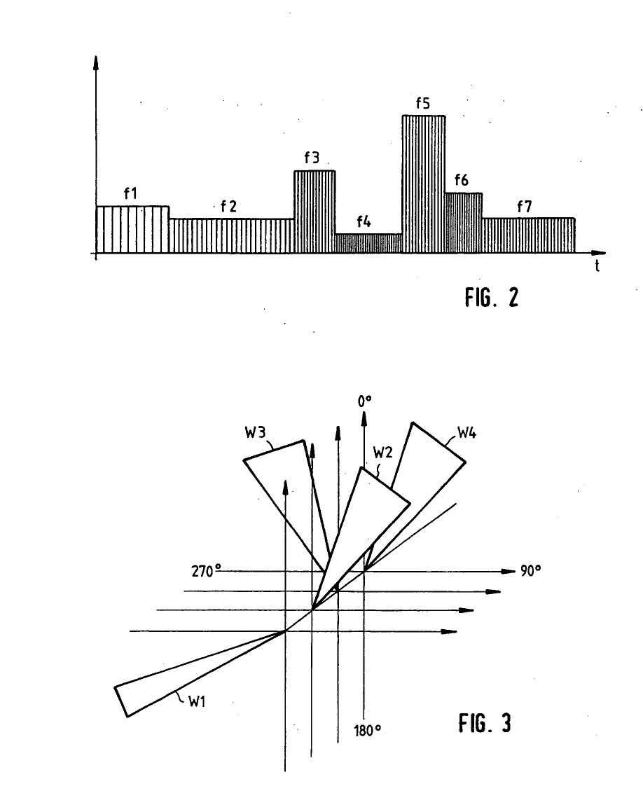

FIG. 2 shows a graph of the frequencies and amplitudes of the generator output signal, which corresponds to the frequency and amplitude response of the transmitted signal sent by the transmission mechanism 6 into the investigation sample. In the example in FIG. 2 seven signal or frequency packages f1-f7 are provided, each sent on a different individual amplitude (shown as height) and for a different time duration (shown as width). The frequencies also differ, as represented by the density shading of the frequency bars f1-f7.

FIG. 3 shows a diagram of the phase shift comparison process performed by the processing element 12. The phase angle value and/or the phase angle areas represent signals on four different transmitter frequencies f1-f4. The respective phase shift angle is regarded as a vector in the phase angle area of 0°-360°. For each transmitter frequency f1-f4, a resulting phase shift value W1-W4 is produced for comparison with a corresponding comparison phase shift value from the comparison sample. This difference is measured by vector analysis (e.g. multiplication) to determine to what extent the resulting phase shift value or phase shift angle lies within the reference value interval assigned to the respective frequency. If the phase shift value lies outside of the interval, a reference value of “0” is assigned. If it lies within the assigned interval, then an evaluation takes place as to the whether it lies more towards the edge of the interval or more towards the center. For example, if the phase shift value lies right in the interval center, then a reference value of “1” is assigned. If it lies more to the edge of the interval, a value between “1” and “0” is assigned, with this value dependent on the deviation from the interval center. The dependency can be linear, exponential, or any other type of distribution function. In this way each phase shift value provides a reference value for the investigation sample against the comparison sample.

In this way each frequency-specific phase shift value is compared to a comparison phase shift value to produce a reference value. The qualifying value of the investigation medium is then produced by summation and averaging of the reference values.

The qualifying value can then be used to determine how well the investigation sample agrees with the comparison sample. If a qualifying value of “1” results, then the investigation sample agrees completely with the comparison sample. In the described example that would mean that all phase shift values of the investigation sample lay right in the respective frequency-referred interval center, therefore all reference values are “1”. If a qualifying value of “0.95” results, then one or more phase shift values deviates from the interval center to deviate and therefore not all reference values were assigned as “1”. A qualifying value of “0.95” means that the investigation sample has 95% agreement with the comparison sample.

There is further the possibility of consulting in the context of a comparison not only the comparison phase shift values of a single comparison sample but the comparison phase shift values of several comparison samples recorded in the control unit 2. For example, if a beer is to be qualified regarding its type, it is conceivable to consider several standard types of beers for the comparison. If one is concerned with a Pilsner beer as an investigation sample, then the comparison phase shift value set of a standard Pilsner beer can be consulted, however, in addition, the comparison value sets for a standard light beer and/or a standard export beer may also be included in the comparison. Each comparative data set has different, type-specific value intervals of the comparison phase shift values, i.e., the intervals are different from type of beer to type of beer. In addition, inevitably the agreement of the determined phase shift values of the investigation sample with the assigned comparison phase shift value intervals of the different beer types is different. For each type comparison a separate qualifying value is determined. For example, in the comparison with the standard Pilsner beer a qualifying value of “0.92” is determined, for the standard light beer a qualifying value of “0.06” and for the standard export beer a qualifying value of “0.02”. That means in the final result the examined beer corresponds to the standard Pilsner beer to 92%, but that it corresponds in addition 6% to the standard light beer and also 2% to the export beer. In this way a fast and continuous classification of the beer can take place during the measurement.

As described above, it is first necessary to determine the comparison reference values. At the beginning of this learning phase parameters such as medium name, type, frequency and transmission duration are entered into the control unit 2 via an input mechanism (such as a keyboard with a display 14 for the qualifying value output) and a known sample, which is qualified as standard, is provided as in a static investigation medium or closed-circuit pipe. The measuring device constantly compares the signal produced by each frequency during the learning phase and determines the corresponding phase shift values. These phase shift values as used to determine corresponding value intervals. This takes place for each frequency, including desired amplitude and duration variations. At the end of this learning phase the standard sample defined is analyzed against its own reference phase shift values for confirmation. In this way each standard sample is processed, creating an appropriate data record for each desired comparison sample and allowing the measuring device to self-normalize.

In the evaluation phase of examining an unknown sample, all the necessary measuring parameters from the control equipment for the comparison sample are called up. It is necessary that transmitted signals with the same frequencies are given, to retrieve the correct comparison phase shift values of the comparison sample or samples desired. Thus, the measuring device according to the invention can compare the unknown sample to produce reference values and/or the qualification value for identification against a known sample or samples.

This concludes the description of a presently preferred embodiment of the invention. The foregoing description has been presented for the purpose of illustration and is not intended to be exhaustive or to limit the invention to the precise form disclosed. Many modifications and variations are possible in light of the above teaching and will be apparent to those skilled in the art. It is intended the scope of the invention be limited not by this description but by the claims that follow.

1. A device for the investigation of a sample of a solid, liquid or gaseous medium, comprising:
a) an ultrasonic transmission mechanism (6) for sending an ultrasonic transmission reference signal into said sample, said transmission mechanism (6) capable of producing several ultrasonic transmission reference signals of different frequencies,
b) an ultrasonic receiving mechanism (9) for receiving of a reflected or transmitted ultrasonic received signal from said sample, said receiving mechanism (9) capable of receiving respective ultrasonic received signals corresponding to respective ultrasonic transmission reference signals, and
c) a processing mechanism (13) for determining a phase shift between a corresponding transmission reference signal and received signal, said processing mechanism (13) determining phase shift values for each pair of transmission reference signal and received signals and computationally determining a qualifying value for said sample based on a comparison of the determined phase shift values with known phase shift values for a reference sample at the respective transmitter frequencies;
wherein said processing mechanism (13) determines said qualifying value from a series reference values, each reference value being a result of each comparison.

2. The device as claimed in claim 1, wherein said processing mechanism (13) compares each determined phase shift with a value interval (W1, W2, W3, W4), in which frequency-specific phase shift values are used for comparison.

3. (canceled)

4. The device as claimed in claim 1, wherein said processing mechanism (13) determines said each reference value from its relationship to the known phase shift value or its situation within the value interval (W1, W2, W3, W4).

5. The device as claimed in claim 4, wherein said processing mechanism (13) determines said qualifying value by summation and averaging of all reference values.

6. The device as claimed in claim 1, additionally comprising a modulator (3) controlling a signal generator (4) whose output signal to said transmission mechanism (6) determines signal characteristics of said ultrasonic transmit signal.

7. The device as claimed in claim 1, wherein said processing mechanism (13) determines the phase difference of the received signal from a transmission reference signal received from a transmission signal generation mechanism.

8. The device as claimed in claim 6, wherein said generator (4) is connected to said processing mechanism (13) and said generator (4) sends said transmission reference signal to said processing mechanism (13).

9. (canceled)

10. A device for the investigation of a sample of a solid, liquid or gaseous medium, comprising:
a) an ultrasonic transmission mechanism (6) for sending an ultrasonic transmission reference signal into said sample, said transmission mechanism (6) capable of producing several ultrasonic transmission reference signals of different frequencies,
b) an ultrasonic receiving mechanism (9) for receiving of a reflected or transmitted ultrasonic received signal from said sample said receiving mechanism (9) capable of receiving respective ultrasonic received signals corresponding to respective ultrasonic transmission reference signals, and
c) a processing mechanism (13) for determining a phase shift between a corresponding transmission reference signal and received signal, said processing mechanism (13) determining phase shift values for each pair of transmission reference signal and received signals and computationally determining a qualifying value for said sample based on a comparison of the determined phase shift values with known phase shift values for a reference sample at the respective transmitter frequencies:
wherein said processing mechanism (13) contains two multiplexers (7, 11), one for receiving said transmission reference signal and the other one for receiving said received signal, and which matches said signals into a respective pair of signals; and
wherein each said respective pair of signals is stored in a respective memory element (8), said multiplexers (7, 11) directing their signals into said respective memory element (8).

11. The device as claimed in claim 10, wherein said multiplexers (7, 11) switch in parallel from one respective memory element (8) to a next respective memory element (8).

12. The device as claimed in claim 11, wherein said switching in parallel of said multiplexers (7, 11) is directed by control signals from said signal generator (4) at the same time as signal switching in modulator (3) taken place.

13. The device as claimed in claim 1, additionally comprising a comparator (19) for the determination of the phase shift for each corresponding pair of signals.

14. A device for the investigation of a sample of a solid, liquid or gaseous medium, comprising:
a) an ultrasonic transmission mechanism (6) for sending an ultrasonic transmission reference signal into said sample, said transmission mechanism (6) capable of producing several ultrasonic transmission reference signals of different frequencies,
b) an ultrasonic receiving mechanism (9) for receiving of a reflected or transmitted ultrasonic received signal from said sample, said receiving mechanism (9) capable of receiving respective ultrasonic received signals corresponding to respective ultrasonic transmission reference signals, and
c) a processing mechanism (13) for determining a phase shift between a corresponding transmission reference signal and received signal, said processing mechanism (13) determining phase shift values for each pair of transmission reference signal and received signals and computationally determining a qualifying value for said sample based on a comparison of the determined phase shift values with known phase shift values for a reference sample at the respective transmitter frequencies;
wherein said processing mechanism (13) is capable of using several comparison samples with different known phase shift values so as to produce qualifying values for each of said several comparison samples.

15. The device as claimed in claim 1, wherein said device iteratively compares said qualifying value against a library of qualifying values for a known sample to self-normalize.

16. (canceled)

17. The device as claimed in claim 12, wherein said device iteratively compares said qualifying value against a library of qualifying values for a known sample to self-normalize.

18. The device as claimed in claim 14, wherein said device iteratively compares said qualifying values against a library of qualifying values for a known sample to self-normalize.
